(19) United States
(12) Patent Application Publication
(10) Pub. No.: US 2012/0087120 A1
(43) Pub. Date: Apr. 12, 2012

(54) GRILLE LIGHT FIXTURE AND HOUSING THEREOF

(75) Inventor: Chen-Lung Fan, Hsinchu City (TW)

(73) Assignee: VALLEY LANE ELECTRONICS CO., LTD., Taipei (TW)

(21) Appl. No.: 13/241,240

(22) Filed: Sep. 23, 2011

(30) Foreign Application Priority Data
Oct. 12, 2010 (TW) 99219602
Jun. 3, 2011 (TW) 100119543

(51) Int. Cl. F21V 11/00; F21V 15/01

(52) U.S. Cl. 362/235; 362/362

(57) ABSTRACT

A grille light fixture and its housing are provided. The grille light fixture includes a housing, at least one light emitting device and an optical film. The housing has a base plate, a surrounding wall upwardly extending from the base plate and a plurality of supporting members disposed at the top of the surrounding wall, wherein the surrounding wall defines an opening. The light emitting device, an LED device for example, is disposed on the base plate. The optical film, a diffusion plate for example, is fixed on the supporting members and covers the opening.

### CROSS-REFERENCE TO RELATED APPLICATION

This application claims the priority benefit of Taiwan application serial no. 99219602, filed Oct. 12, 2010 and the priority benefit of Taiwan application serial no. 100119543, filed Jun. 3, 2011. The entirety of each of the above-mentioned patent applications is hereby incorporated by reference herein and made a part of this specification.

### BACKGROUND OF THE INVENTION

1. Field of the Invention

The invention generally relates to a grille light fixture and a grille light fixture housing, and more particularly, to a grille light fixture and a grille light fixture housing easier to be assembled and having lower material cost.

2. Description of Related Art

The conventional grille light fixture is composed of a 60 cm×60 cm×(4.5−6.5) cm baking varnish metallic housing, a reflector comprising mirror-surface aluminium sheets, a grille and four 20 W lamp tubes. The light emitting diode (LED) grille light fixture evolves from the conventional grille light fixture, wherein the LED light source substitutes 20 W lamp tubes.

Referring to FIGS. 1A and 1B, FIGS. 1A and 1B are exploded and assembled schematic diagrams of a conventional LED grille light fixture. The conventional LED grille light fixture 100 has a metallic housing 110 and a plurality of LED aluminium strips 120, in which the LED aluminium strips 120 are fixed onto the metallic housing 110 by screws. Since the LED light source is a point light source and the luminance of a single point light source is not enough to meet the requirement of total luminance, it is needed to use plural point light sources, usually including 25-50 high power LEDs or hundreds of low power LEDs, and the quantity of the point light sources depends on the luminance level of the single LED light source and the demand of total luminance. These LED light sources must be fixed on metallic heat sinks to dissipate the heat sufficiently and thereby the expected light-emitting efficiency and lifetime can be achieved. In this regard, the LED light sources are often adhered to aluminium sheets having copper traces formed thereon to form LED aluminium strips 120, followed by fixing the LED aluminium strips 120 on the metallic housing 110 by screws to achieve heat dissipating effect. The copper traces on the LED aluminium strips 120 are used for achieving the serial/parallel electrical connections between individual LED light sources.

Referring to FIGS. 1A and 1B again, the conventional LED grille light fixture 100 further includes a diffusion plate 130 and a metallic hollow upper cap 140. The diffusion plate 130 covers the metallic housing 110 and the LED aluminium strips 120, and then the metallic hollow upper cap 140 and the metallic housing 110 are assembled to fix the diffusion plate 130. Since an LED is a point light source, it is easy to lead discomfort caused by glare when naked eyes directly gaze at the light source. Therefore, an additional diffusion plate made of polycarbonate or acrylic resin must be disposed over the light source so that the light produced by the LED light sources can be uniformly emitted out from the diffusion plate. As a result, the material cost of the metallic housing (including the metallic housing 110 and the metallic hollow upper cap 140) of the conventional LED grille light fixture 100 is quite high, which makes its selling price stay high and is adverse to the promotion of the LED grille light fixture 100.

### SUMMARY OF THE INVENTION

Accordingly, the invention is directed to a grille light fixture and a grille light fixture housing easy to be assembled and having lower material cost.

The present invention provides a grille light fixture. The grille light fixture comprises a housing, at least one light emitting device and an optical film. The housing has a base plate, a surrounding wall upwardly extending from the base plate and a plurality of supporting members disposed at the top of the surrounding wall, wherein the surrounding wall defines an opening. The light emitting device is disposed on the base plate and the optical film is fixed on the supporting members and covers the opening.

In an embodiment of the present invention, the optical film comprises a diffusion plate.

In an embodiment of the present invention, the light emitting device comprises an LED device.

In an embodiment of the present invention, the LED device comprises an aluminium strip and at least one LED disposed on the aluminium strip.

In an embodiment of the present invention, the housing further comprises a plurality of pressed claws respectively disposed on the supporting members, and the pressed claws bendably lock the optical film to fix it onto the supporting members.

In an embodiment of the present invention, the grille light fixture further comprises a plurality of light shielding tapes respectively adhered to edges of the optical film to expose a light transmissible region and cover the pressed claws.

In an embodiment of the present invention, the grille light fixture further comprises a plurality of light shielding tapes respectively adhered to edges of the optical film to expose a light transmissible region.

In an embodiment of the present invention, each of the supporting members comprises a supporting portion horizontally extending from the top of the surrounding wall.

In an embodiment of the present invention, each of the supporting members comprises a strengthening portion downwardly extending from the supporting portion.

In an embodiment of the present invention, the housing further comprises a plurality of pressed claws respectively disposed on the supporting portions of the supporting members, and the pressed claws bendably lock the optical film to fix it onto the supporting portions of the supporting members.

In an embodiment of the present invention, the grille light fixture further comprises a plurality of light shielding tapes respectively adhered at edges of the optical film to expose a light transmissible region and cover the pressed claws.

In an embodiment of the present invention, the pressed claws are disposed at the utmost edges of the supporting portions of the supporting members.

In an embodiment of the present invention, the optical film comprises a diffusion plate.

In an embodiment of the present invention, the light emitting device comprises an LED device.

In an embodiment of the present invention, the LED device comprises an aluminium strip and at least one LED disposed on the aluminium strip.

The present invention also provides a grille light fixture housing, suitable for mounting at least one light emitting device and an optical film thereon. The grille light fixture housing comprises a base plate, a surrounding wall and a plurality of supporting members. The base plate is provided for mounting the light emitting device thereon. The surrounding wall upwardly extends from the base plate and defines an opening, and the supporting members disposed at the top of the surrounding wall are provided for fixing the optical film thereon to cover the opening.

In an embodiment of the present invention, the grille light fixture housing further comprises a plurality of bendable pressed claws, respectively disposed on the supporting members, used for fixing the optical film onto the supporting members by bending the pressed claws.

In an embodiment of the present invention, the pressed claws are disposed at the utmost edges of the supporting members.

In an embodiment of the present invention, each of the supporting members comprises a supporting portion horizontally extending from the top of the surrounding wall.

In an embodiment of the present invention, each of the supporting members comprises an strengthening portion downwardly extending from the supporting portion.

Based on the descriptions above, not like the conventional grille light fixture, the grille light fixture and the grille light fixture housing of the present invention do not need any metallic hollow upper cap, and therefore they have lower material cost and are easy to be assembled and utilized, and it will be advantageous to promote green energy saving LED grille light fixtures.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1A is an exploded schematic diagram of a conventional LED grille light fixture.

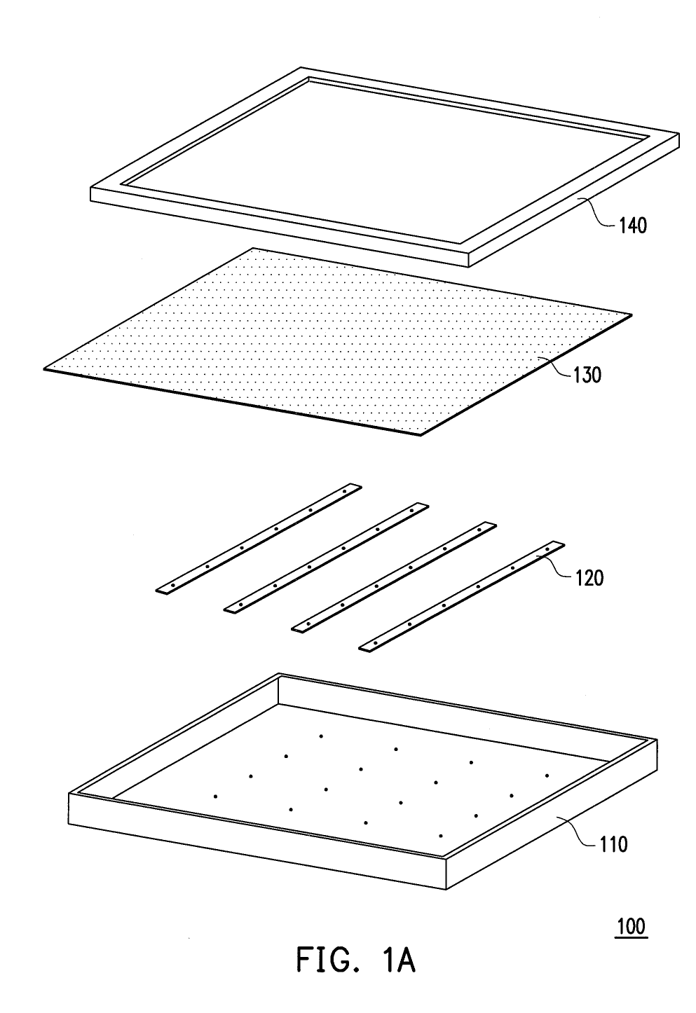

FIG. 1B is an assembled diagram of the above-mentioned LED grille light fixture.

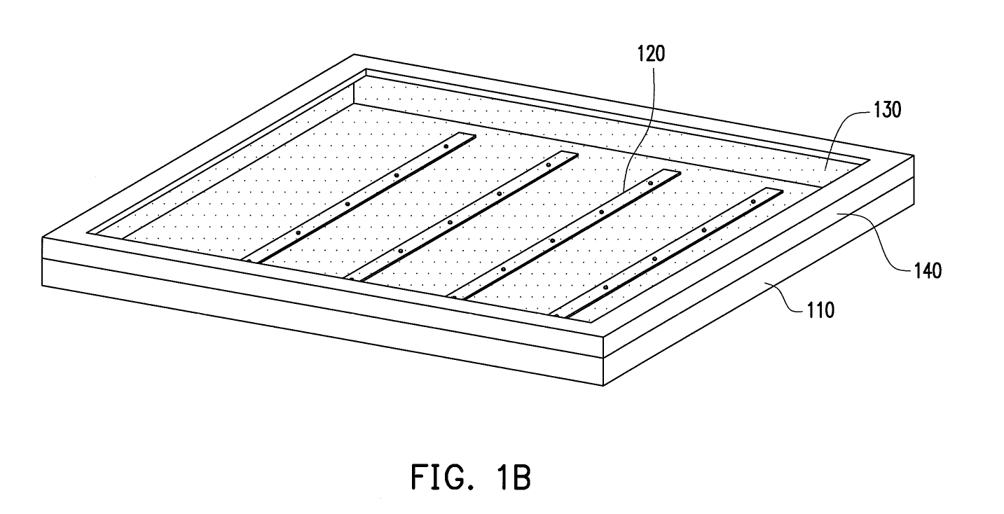

FIG. 2 is an exploded schematic diagram of a grille light fixture according to an embodiment of the present invention.

FIG. 3A is a schematic diagram of the grille light fixture housing in FIG. 2.

FIG. 3B is a partially enlarged diagram of the grille light fixture housing in FIG. 3A.

FIG. 4A is an assembled diagram of the grille light fixture housing, the light emitting device and the optical film in FIG. 2.

FIG. 4B is a partially enlarged diagram of assembly of the grille light fixture housing, the light emitting device and the optical film in FIG. 4A.

FIG. 5 is an assembled diagram of the grille light fixture housing, the light emitting device, the optical film and the light shielding tapes in FIG. 2.

### DESCRIPTION OF THE EMBODIMENTS

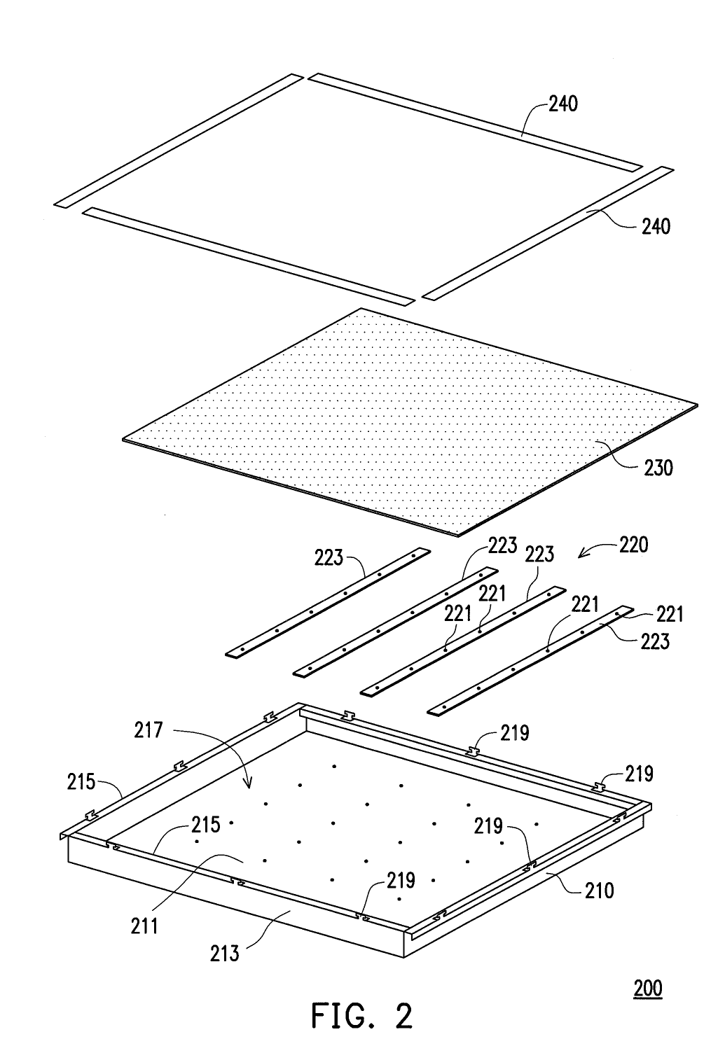

FIG. 2 is an exploded schematic diagram of a grille light fixture according to an embodiment of the present invention. Referring to FIG. 2, a grille light fixture 200 of the present embodiment comprises a housing 210, a plurality of light emitting devices 220 and an optical film 230. In the embodiment of the present invention, the housing 210 is a metallic housing which is formed by, for example, punching, bending and then welding, or formed by joining a plurality of metallic sheets together. The material of the housing 210 is not limited to metal. The above-mentioned light emitting devices 220 are, for example, those whose light sources are light emitting diodes. In the embodiment of the present invention, each of the light emitting devices 220 has a heat-conductive aluminium strip 223 and a plurality of light emitting diodes 221 disposed on the aluminium strip 223, wherein the metallic housing 210 has rows of screw holes formed therein and the aluminium strips 223 of the light emitting devices 220 can be fixed in the metallic housing 210 by screws.

Since a light emitting diode is a point light source, it is easy to lead discomfort caused by glare when naked eyes directly gaze at the light source. Therefore, an additional optical film 230 must be disposed over the light source so that the light produced by the LED light source can be uniformly emitted. In the embodiment of the present invention, the optical film 230 comprises, for example, a diffusion plate or a light transmissible plate made of polycarbonate or acrylic resin. In other embodiments of the invention, the optical film 230, for example, comprises those having strip-like, grid-like or patterned microlenses or Fresnel lenses, or those having both functions of a diffusion plate and the above-mentioned lenses. In another embodiment of the invention, the grille light fixture 200 further comprises a plurality of light shielding tapes 240.

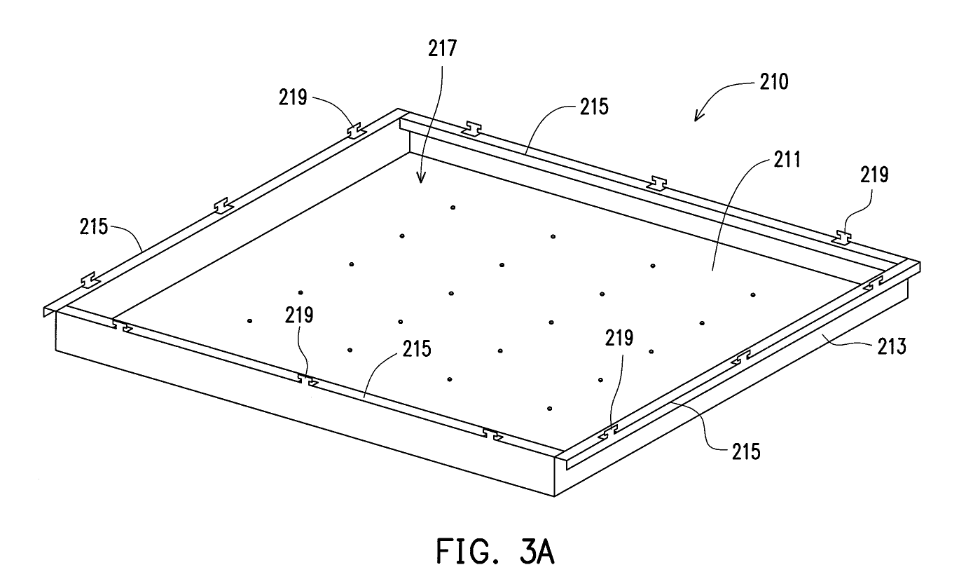

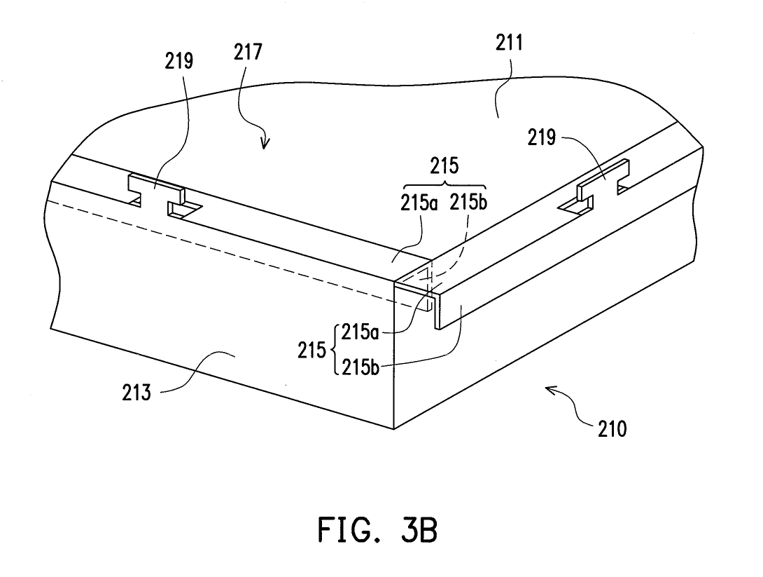

Referring to FIGS. 2, 3A and 3B, FIG. 3A is a schematic diagram of the grille light fixture housing 210 in FIG. 2 and FIG. 3B is a partially enlarged diagram of the grille light fixture housing 210 in FIG. 3A. The housing 210 has a base plate 211, a surrounding wall 213 upwardly extending from the peripheral of the base plate 211 and a plurality of supporting members 215 horizontally extending from the top of the surrounding wall 213. As described previously, the base plate 211 has rows of screw holes formed therein, used for fixing the light emitting devices 220 thereon by screws. The surrounding wail 213 defines an opening 217. The housing 210 further comprises a plurality of pressed claws 219 respectively disposed on the supporting members 215, wherein the pressed claws 219 can be bent inwardly to lock the optical film 230 and make it fixed onto the supporting members 215.

Some of the supporting members 215 extend towards the opening 217 from the top of the surrounding wall 213, while some extend outwardly from the top of the surrounding wall 213. Each of the supporting members 215 has a supporting portion 215a horizontally extending from the top of the surrounding wall 213 and a strengthening portion 215b downwardly extending from the supporting portions 215a. The strengthening portion 215b of each supporting member 215 can reinforce the structure strength of the supporting portion 215a to maintain the flatness of the supporting portion 215a. In the embodiment of the present invention, the pressed claws 219 and the supporting members 215 are integrally formed by a metal punching process, and the pressed claws 219 are located at the utmost edges of the supporting portions 215a. In other embodiments of the invention, the pressed claws 219 are formed on the supporting portions 215a by, for example, welding or laminating process, and the locations of the pressed claws 219 are not limited to the utmost edges of the supporting portions 215a.

The heights of the pressed claws 219 depend on both the thickness of the optical film 230 and the lengths of the portions of the bent pressed claws 219 overlaying the optical film 230. The pressed claws 219 cannot effectively fix the optical film 230 if their lengths are not sufficient, and contrarily, if their lengths are too much, the pressed claws 219 as bent may extend over the preserved lateral boundary of the suspended frame ceiling when the grille light fixture 200 is installed onto the suspended frame ceiling. It is adverse to the aesthetics of the suspended frame ceiling, therefore the heights of the pressed claws 219 preferably are 2 mm-30 mm.

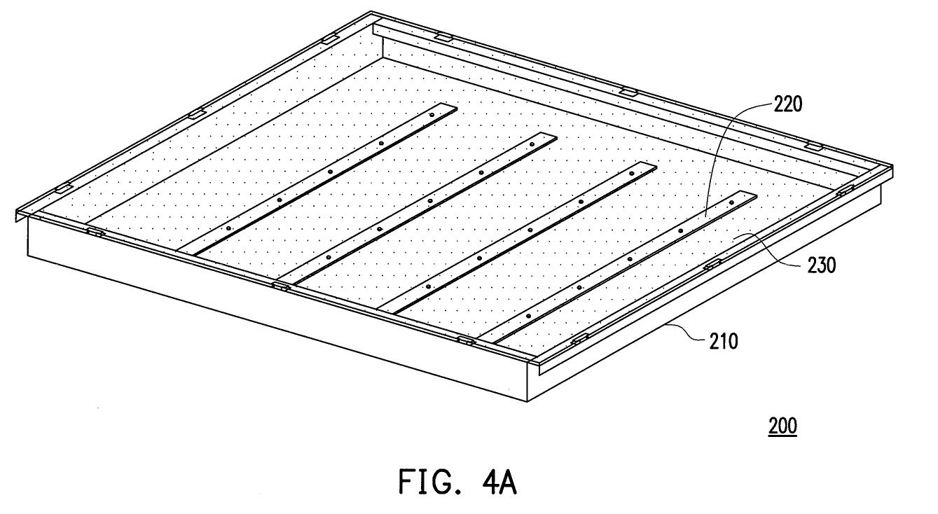

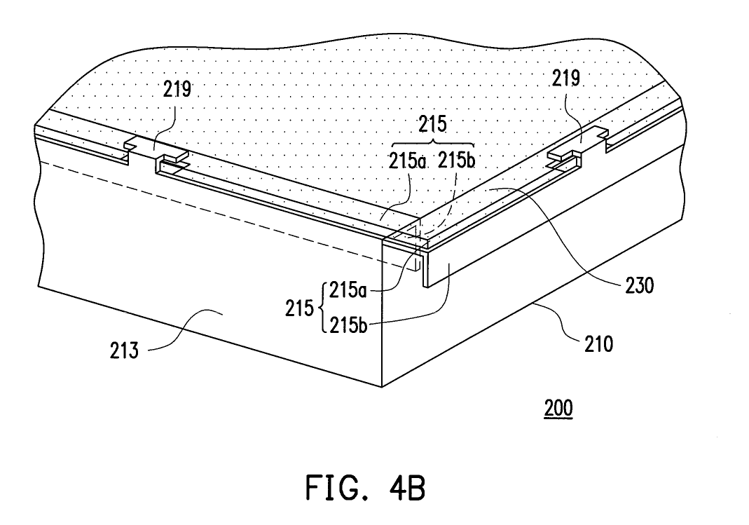

Referring to FIGS. 2, 4A and 4B, FIG. 4A is an assembled diagram of the housing 210, the light emitting device 220 and the optical film 230 of the grille light fixture 200 in FIG. 2 and FIG. 4B is a partially enlarged diagram of the housing 210, the light emitting device 220 and the optical film 230 of the grille light fixture 200 in FIG. 4A. When assembling the grille light fixture 200, first, the light emitting devices 220 onto the base plate 211 of the grille light fixture housing 210, then the optical film 230 is used to cover the opening 217 of the grille light fixture housing 210, so that the optical film 230 could be located within the area surrounded by the pressed claws 219 and the rim section of the optical film 230 is located on the supporting portions 215a of the supporting members 215. Since the supporting portions 215a of the supporting members 215 extend horizontally, the optical film 230 can be flatly disposed on the supporting portions 215a of the supporting members 215. Thereafter, the pressed claws 219 are bent inwardly to fix the optical film 230 onto the supporting members 215.

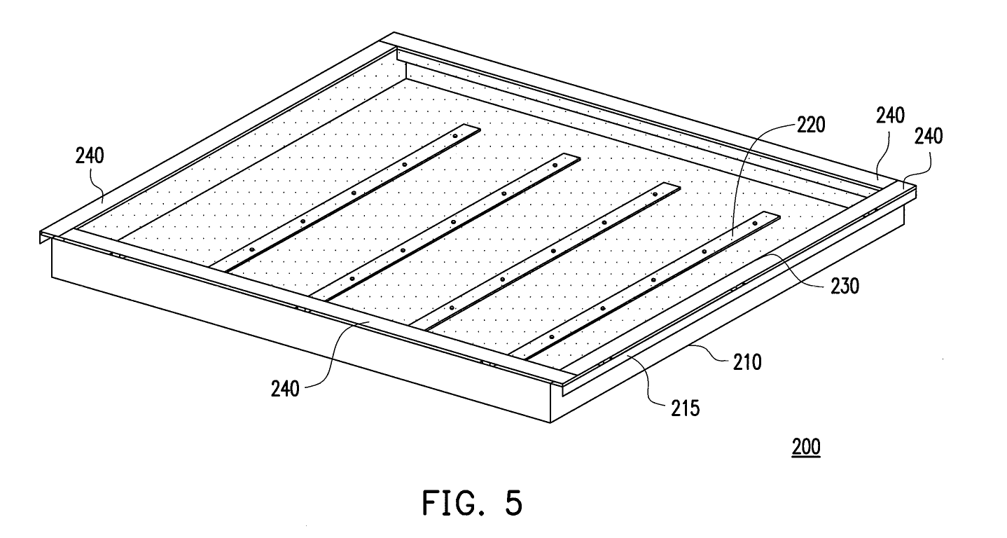

Referring to FIGS. 2 and 5, FIG. 5 is an assembled diagram of the grille light fixture housing 210, the light emitting device 220, the optical film 230 and the light shielding tapes 240 shown in FIG. 2. After assembling the optical film 230 with the grille light fixture housing 210, those bent pressed claws 219 are revealed so that the peripheral of the grille light fixture 200 appears not neat and some of light may be emitted from the edges of the optical film 230. In this regard, light shielding tapes 240 are adhered to the rim section of the optical film 230 so as to cover those bent pressed claws 219 and expose a light transmissible region located around the central.

The light shielding tapes 240 are made of, for example, aluminium foil tape. In other embodiments of the present invention, the light shielding tapes 240 can also be the tapes having light shielding effect in different colors or can be formed by directly spraying light-shielding paints over the rim section of the optical film 230. In addition, the widths of the light shielding tapes 240 are quite critical because light emitted from the edges of the optical film 230 cannot be blocked if their widths are narrow, while the effective light transmissible region may be reduced if their widths are too broad. Therefore, in the embodiment of the present invention, the widths of the light shielding tapes 240 preferably are 2 mm-150 mm. In other embodiments of the invention, the light shielding tapes 240 can also be frame-like light shielding tapes formed integrally.

Based on the descriptions above, unlike the conventional grille light fixture, the grille light fixture and the grille light fixture housing of the present invention do not need any metallic hollow upper cap, and therefore they have lower material cost and are easy to be assembled and utilized. This is advantageous to promote green energy saving LED grille light fixtures.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive.

What is claimed is:

1. A grille light fixture, comprising:
a housing having a base plate, a surrounding wall upwardly extending from the base plate and a plurality of supporting members disposed at the top of the surrounding wall, wherein the surrounding wall defines an opening;
at least one light emitting device disposed on the base plate; and
an optical film fixed on the supporting members and covering the opening.

2. The grille light fixture of claim 1, wherein the optical film comprises a diffusion plate.

3. The grille light fixture of claim 1, wherein the light emitting device comprises an aluminium strip and at least one light emitting diode disposed on the aluminium strip.

4. The grille light fixture as claimed in claim 1, wherein the housing further comprises a plurality of pressed claws respectively disposed on the supporting members, and the pressed claws bendably lock the optical film to fix the optical film onto the supporting members.

5. The grille light fixture as claimed in claim 1, further comprising a plurality of light shielding tapes respectively adhered to edges of the optical film to expose a light transmissible region.

6. The grille light fixture as claimed in claim 1, wherein each of the supporting members comprises a supporting portion horizontally extending from the top of the surrounding wall.

7. The grille light fixture as claimed in claim 6, wherein the housing further comprises a plurality of pressed claws respectively disposed on the supporting portions of the supporting members, and the pressed claws bendably lock the optical film to fix the optical film onto the supporting portions of the supporting members.

8. A grille light fixture housing, suitable for mounting at least one light emitting device and an optical film thereon, the grille light fixture housing comprising:
a base plate provided for mounting the light emitting device thereon;
a surrounding wall upwardly extending from the base plate, wherein the surrounding wall defines an opening; and
a plurality of supporting members disposed at the top of the surrounding wall being provided for fixing the optical film thereon to covering the opening.

9. The grille light fixture housing as claimed in claim 8, further comprising a plurality of bendable pressed claws, respectively disposed on the supporting members, used for fixing the optical film onto the supporting members by bending the pressed claws.

10. The grille light fixture housing as claimed in claim 8, wherein each of the supporting members comprises a supporting portion horizontally extending from the top of the surrounding wall.
